(19) United States
(12) Patent Application Publication
(10) Pub. No.: US 2018/0029807 A1
(43) Pub. Date: Feb. 1, 2018

(54) SUCTION DEVICE

(71) Applicant: Fanuc Corporation, Yamanashi (JP)

(72) Inventor: Hajime OONO, Yamanashi (JP)

(73) Assignee: Fanuc Corporation, Yamanashi (JP)

(21) Appl. No.: 15/657,440

(22) Filed: Jul. 24, 2017

(30) Foreign Application Priority Data
Jul. 27, 2016 (JP) 2016147735
Jun. 9, 2017 (JP) 2017114130

(51) Int. Cl. B65G 47/91; B25J 15/06; B65G 49/06

(52) U.S. Cl. CPC B65G 47/917; B65G 49/061; B25J 15/0633; B25J 15/0658; F16M 11/041

(57) ABSTRACT

There is provided a suction device including a suction portion for gripping a suction target by using a sucking force in a direction, and a pressing unit for pressing the suction target gripped by the suction portion in a direction opposite to the sucking force, and for terminating a gripped state, where the pressing unit includes a pressing member, for pressing the suction target, provided in a manner capable of advancing and retracting along the direction of the sucking force, and a drive unit for advancing and retracting the pressing member.

### CROSS-REFERENCE TO RELATED APPLICATIONS

This application is based on and claims priority to Japanese Patent Application No. 2016-147735 filed on Jul. 27, 2016 and Japanese Patent Application No. 2017-114130 filed on Jun. 9, 2017, the entire contents of which are incorporated herein by reference.

### TECHNICAL FIELD

The present invention relates to a suction device.

### BACKGROUND ART

Conventionally, there is a known suction device which includes a pin that is fixed inside a suction pad having a cylindrical concertina portion which is open upward and which grips a flat suction target, such as a glass plate, by being positioned below the suction target (see PTL 1).

The suction device changes the internal pressure of the suction pad to negative pressure and places a suction target in a gripped state by extending the concertina portion in a state where an annular pad arranged at an open end of the suction pad is in contact with a lower surface of the suction target, and also terminates the sucking state by pushing the suction target upward by the pin while retracting the concertina portion and bringing the internal pressure of the suction pad closer to atmospheric pressure.

### CITATION LIST

### Patent Literature

### {PTL 1}

Japanese Unexamined Patent Application, Publication No. 2007-245243

### SUMMARY OF INVENTION

An aspect of the present invention provides a suction device including a suction portion for gripping a suction target by using a sucking force in a direction; and a pressing unit which presses the suction target gripped by the suction portion in a direction opposite to the sucking force and which terminates a gripped state, wherein the pressing unit includes a pressing member provided in a manner capable of advancing and retracting along the direction of the sucking force in order to press the suction target, and a drive unit which advances and retracts the pressing member.

### BRIEF DESCRIPTION OF DRAWINGS

FIG. 1 is a front view showing a suction device according to an embodiment of the present invention.

FIG. 2 is a partially sectional overall structure diagram showing the suction device of FIG. 1.

FIG. 3 is a front view showing a state where a workpiece is gripped by the suction device of FIG. 1.

FIG. 4 is a partially sectional overall structure diagram showing the suction device of FIG. 3.

FIG. 5 is a partially sectional overall structure diagram showing a state where a gripped state of a workpiece by the suction device of FIG. 1 is terminated.

FIG. 6 is a front view showing a first modified example of the suction device of FIG. 1.

FIG. 7 is a front view showing a second modified example of the suction device of FIG. 1.

FIG. 8 is a partially sectional overall structure diagram showing the suction device of FIG. 7.

FIG. 9 is an overall structure diagram showing, from a side direction, a state where a gripped state of workpieces by the suction device of FIG. 7 is terminated.

FIG. 10 is a partially sectional overall structure diagram showing the suction device of FIG. 9 from another side direction.

FIG. 11 is a front view showing a third modified example of the suction device of FIG. 1.

FIG. 12 is a partially sectional overall structure diagram showing the suction device of FIG. 11.

FIG. 13 is a partially sectional overall structure diagram showing a fourth modified example of the suction device of FIG. 1.

FIG. 14 is a partially sectional overall structure diagram showing a state where a gripped state of workpieces by the suction device of FIG. 13 is terminated.

### DESCRIPTION OF EMBODIMENTS

Hereinafter, a suction device 1 according to an embodiment of the present invention will be described with reference to the drawings.

For example, the suction device 1 according to the present embodiment is a device that is attached to a distal end of an arm of a robot (not shown), which is used to grip and convey, by operation of the robot, a workpiece (suction target) A to be handled, and to let the workpiece A go by terminating the gripped state at a predetermined location. In the present embodiment, a case is described where a resin molded product, which is molded by an injection molding machine (not shown), is used as a workpiece A.

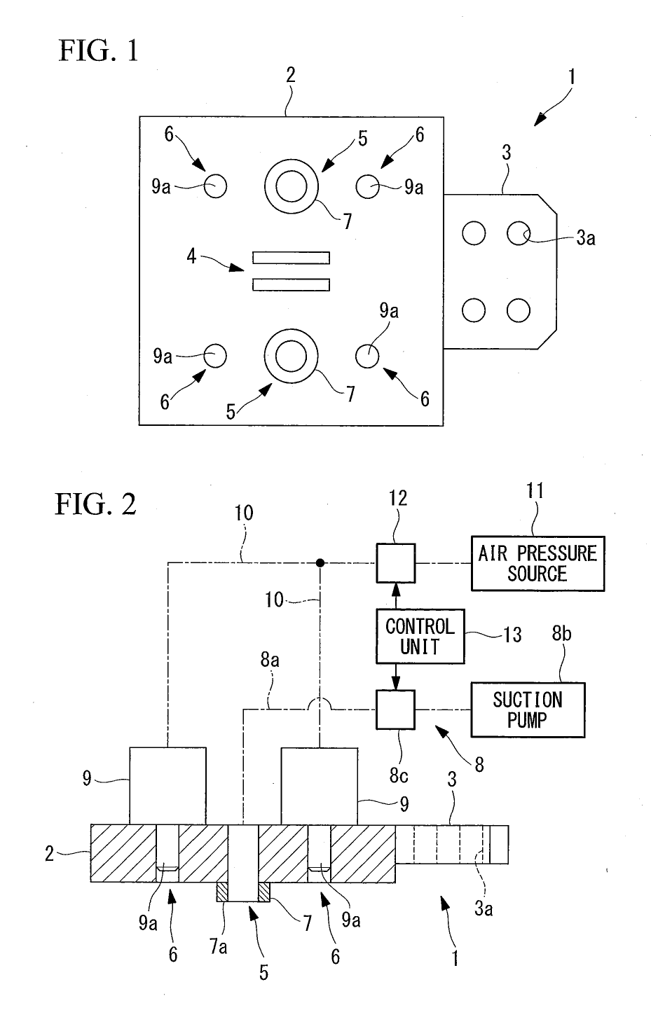

As shown in FIGS. 1 to 4, the suction device 1 includes a main body 2, and an attachment portion 3 for attaching the main body 2 to a robot. The main body 2 includes a sprue chuck 4, which is arranged substantially at the center and which is capable of opening or closing so as to hold a sprue B that is formed at the time of resin molding, a plurality of suction portions 5 arranged around the sprue chuck 4, and pressing units 6 arranged on both sides of each suction portion 5 in a manner sandwiching the corresponding suction portion 5. In the drawings, “3a” is a hole enabling attachment to a robot by a bolt or the like.

In the example shown in FIG. 1, the suction portion 5 is provided at two positions sandwiching the sprue chuck 4. For example, each suction portion 5 includes an annular suction pad 7, and a pressure-reducing device 8 for reducing the pressure inside the suction pad 7. The suction pad 7 is formed of a material such as elastically deformable rubber having a contact surface 7a which comes into contact with a surface of a workpiece A. The pressure-reducing device 8 includes a pipe 8a which is connected to the inside of the suction pad 7, a suction pump 8b connected on a proximal end side of the pipe 8a, and a valve 8c for switching the inside of the pipe 8a between a reduced pressure state and an atmospheric pressure state.

For example, the pressing unit 6 includes an air cylinder 9, an air pressure source 11 for supplying air pressure to the air cylinder 9 through a pipe 10, and a valve (drive unit) 12 for switching on or off supply of air pressure from the air pressure source 11.

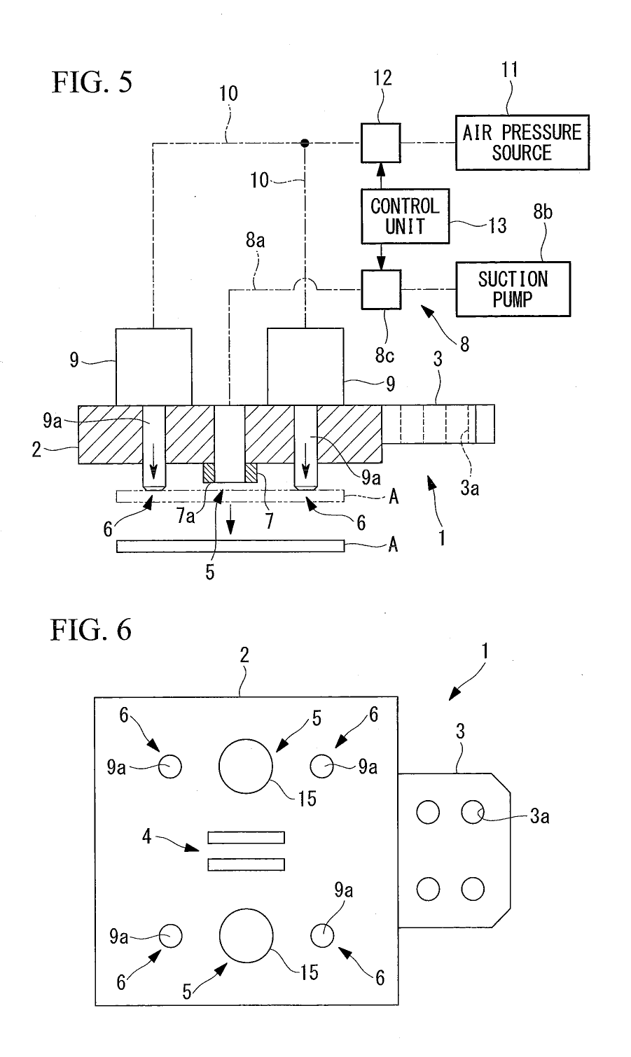

The air cylinder 9 includes a piston rod (pressing member) 9a, which can be advanced or retracted between a position recessed toward the main body 2 side than a flat surface including the contact surface 7a of the suction pad 7, as shown in FIG. 4, and a position protruding, toward the opposite side of the main body 2, from the flat surface including the contact surface 7a of the suction pad 7, as shown in FIG. 5. The air cylinder 9 causes the piston rod 9a to protrude by supplying air pressure, and moves the piston rod 9a in the retracting direction by, for example, a built-in spring, not shown, by stopping the air pressure.

A control unit 13 is connected to the valves 8c, 12, and timings of sucking by the suction portion 5 and pressing by the pressing unit 6 are adjusted by command signals transmitted from the control unit 13. For example, if pressing by the pressing unit 6 is performed in the state of firm grip by the suction portion 5, a load is applied to the workpiece A, and therefore the control unit 13 performs control such that a pressing operation of the pressing unit 6 is started at a predetermined timing after sucking by the suction portion 5 is stopped.

A function of the aforementioned suction device 1 according to the present embodiment will be described below.

In order to grip a workpiece A by using the suction device 1 according to the present embodiment in order to convey the workpiece A by operation of the robot and to release the workpiece A at a desired position by terminating the gripped state, the main body 2 of the suction device 1 is moved by operating the robot, and the main body 2 is arranged at a releasing position of the workpiece A.

At this time, the control unit 13 controls the two valves 8c, 12, sets the piston rod 9a of the air cylinder 9 in a recessed state, and sets the inside of the pipe 8a of the suction portion 5 in an atmospheric pressure state.

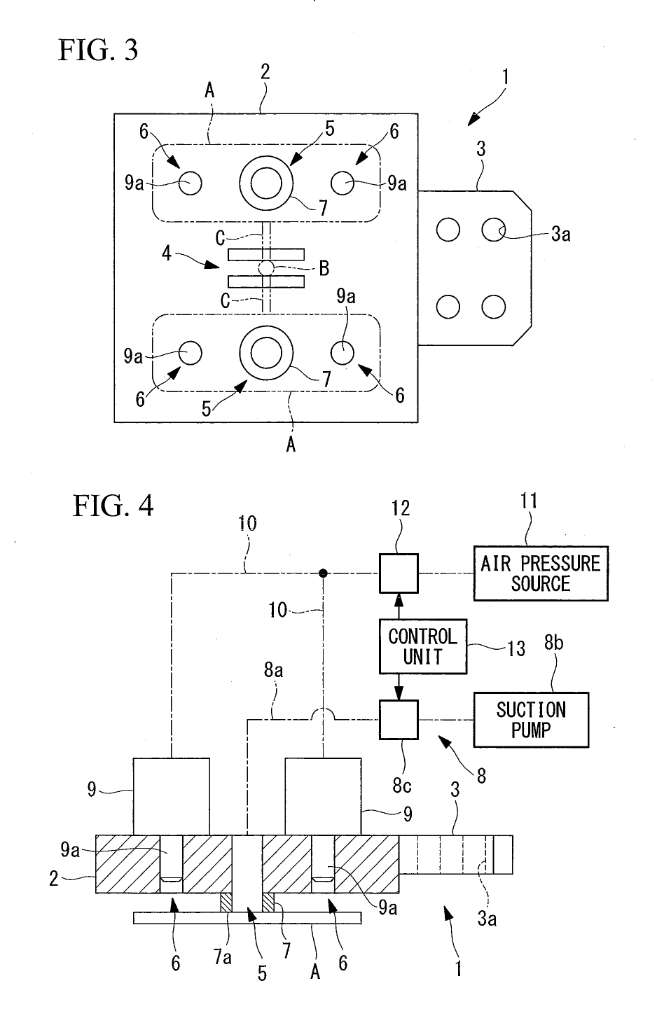

In the case where the workpiece A is a resin molded product, at the time of transfer of the workpiece A from an injection molding machine to the suction device 1, the workpiece A is transferred by the injection molding machine in a state where the workpiece A is separated by a gate from the sprue B and a runner C, and as shown by a chain line in FIG. 3, the sprue B and the runner C are held by the sprue chuck 4, and the workpiece A separated from the runner C is gripped by the suction portion 5.

Next, the contact surface 7a of the suction pad 7 of the suction portion 5 provided to the main body 2 is brought sufficiently close to the surface of the workpiece A by operation of the robot. In this state, the control unit 13 opens the valve 8c, and the air inside the pipe 8a of the suction portion 5 is sucked by the suction pump 8b, and thus, the inside of the suction pad 7 is placed in a reduced pressure state, and the workpiece A is gripped by the contact surface 7a of the suction pad 7, as shown in FIG. 4. The workpiece A may thus be removed from the injection molding machine.

Then, the workpiece A gripped by the suction device 1 is conveyed to a desired destination by operation of the robot. Then, the control unit 13 controls the valve 8c and switches the reduced pressure state of the pipe 8a to the atmospheric pressure state, and also, controls the valve 12 and supplies air pressure from the air pressure source 11 to the air cylinder 9, and causes the piston rod 9a to protrude, as shown in FIG. 5.

The distal end of the protruding piston rod 9a thereby abuts against the surface of the workpiece A which is arranged at the suction pad 7 in a gripped state, and presses the workpiece A in an opposite direction from the sucking force, and thus, a gap is formed between the suction pad 7 and the workpiece A and the gripped state is terminated, and the workpiece A may be released accurately at the destination. Also, at this time, sucking by the suction portion 5 is stopped before pressing by the piston rod 9a is performed, and thus, the sucking force of the suction portion 5 is reduced, and application of an excessively large load on the workpiece A by the pressing by the piston rod 9a may be prevented.

Furthermore, according to the suction device 1 of the present embodiment, the workpiece A is pressed by the two piston rods 9a arranged at positions sandwiching the suction pad 7, and thus, there is an advantage that, even if the gripped state is release while there is still a sucking force from the suction portion 5, the posture of the workpiece A may be stably maintained. Accordingly, the workpiece A whose gripped state by the suction device 1 is released may be prevented from falling in an unexpected direction or being released at the destination at unexpected posture due to being pulled by the remaining sucking force.

Moreover, according to the suction device 1 of the present embodiment, the suction portion 5 and the pressing unit 6 may be independently operated, and thus, there are advantages that there is no restriction on the posture of the workpiece A at the time of gripping the workpiece A and therefore the workpiece A may be gripped at any posture, and that the workpiece A may be released at any posture.

Additionally, in the present embodiment, the workpiece A is gripped by reducing the pressure inside the annular suction pad 7 as the suction portion 5, but in the case where the workpiece A is made of a magnetic material, a magnet 15, which generates a magnetic force, such as a permanent magnet or an electromagnet, may be used as the suction portion 5 instead. In this case, the magnet 15 forming the suction portion 5 does not have to be annular, and may be disc-shaped, as shown in FIG. 6, or may have any other shape.

If the suction portion 5 is formed by an electromagnet, timings of on/off of the sucking force and of pressing by the pressing unit 6 may be appropriately adjusted, in the same manner as with the air pressure, by switching between generation and non-generation of the magnetic force.

Furthermore, in the present embodiment, a case is illustrated where two suction portions 5 and two sets of pressing units 6 are provided, but any number of suction portions 5 and pressing units 6 may be provided instead. Also, the timing of on/off of the pressing units 6 for releasing workpieces A gripped by respective suction portions 5 may be made different at each of the suction portions 5. This allows a plurality of workpieces A gripped at the same time to be separately released at different destinations during conveyance by the robot.

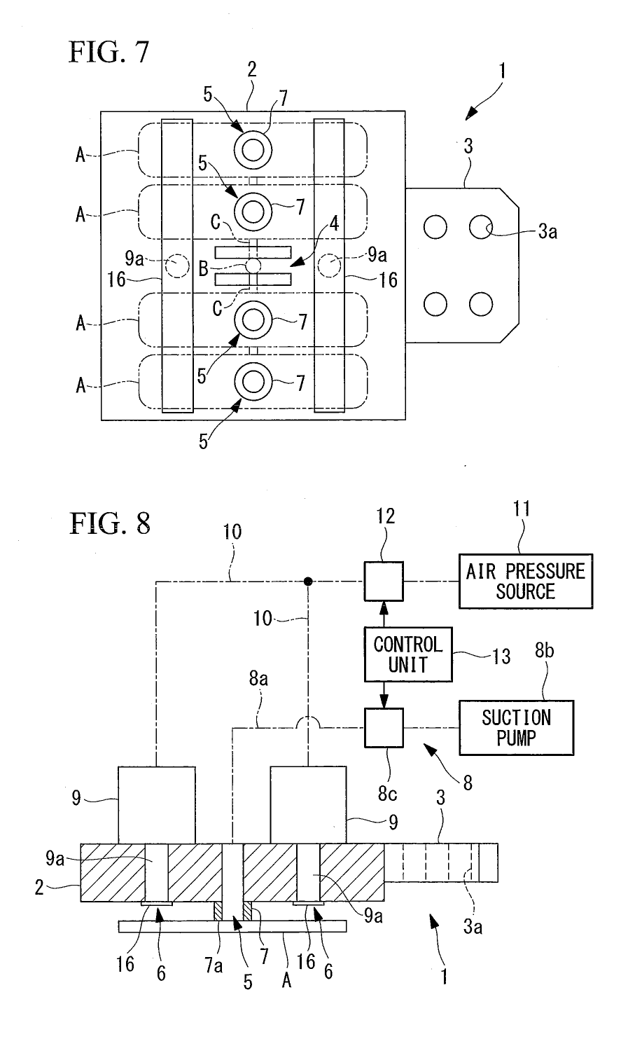

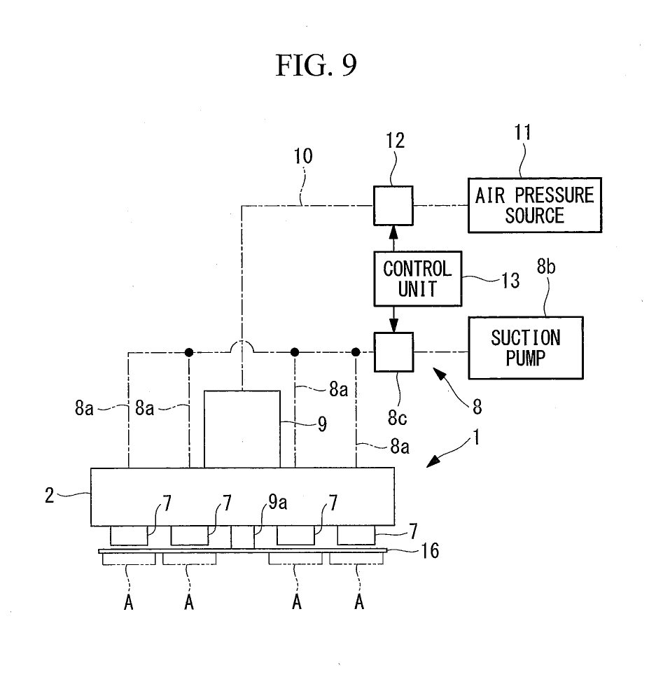

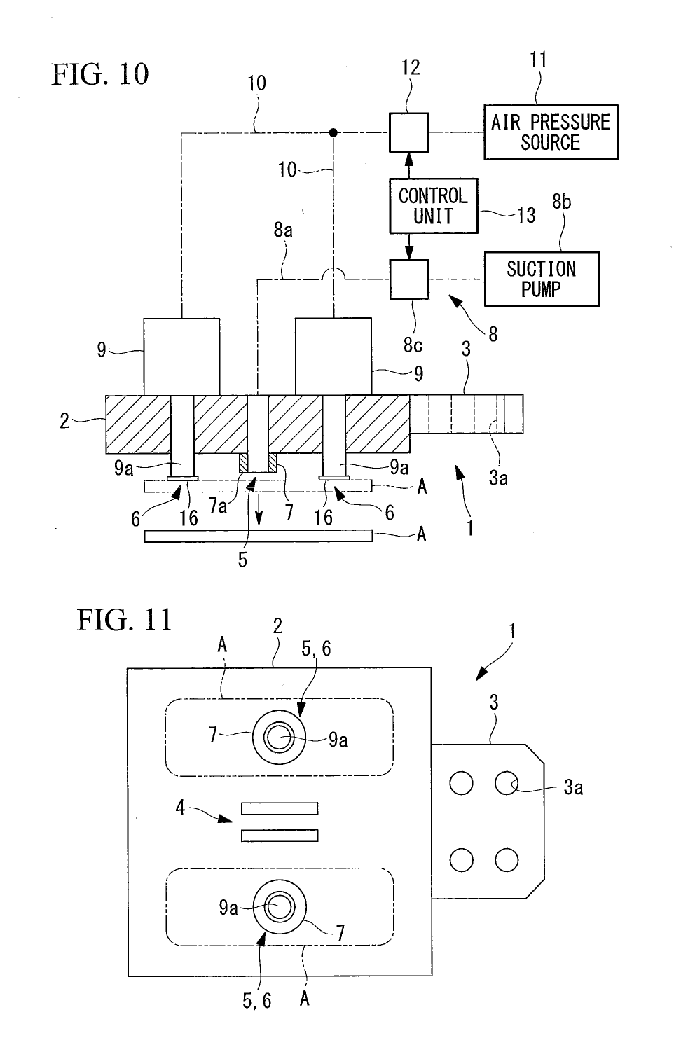

Moreover, in the present embodiment, a pressing unit 6 for pressing a gripped workpiece A is provided to each suction portion 5. Instead of the configuration, a plurality of workpieces A gripped by a plurality of suction portions 5 may be pushed out at the same time by a group of pressing units 6, as shown in FIGS. 7 to 10. In the example shown in FIGS. 7 to 10, four workpieces A gripped by four suction portions 5 are pushed out at the same time by a pair of pressing units 6.

A strip-shaped member 16 is fixed at the distal end of the piston rod 9a of each air cylinder 9 in a manner extending across a plurality of workpieces A in the aligned direction of the workpieces A, and when the piston rod 9a of the air cylinder 9 is pushed out, the strip-shaped member 16 presses all the workpieces A at the same time.

Accordingly, even if the number of workpieces A is great, the number of pressing units 6 may be reduced, and there is an advantage that the suction device 1 may be easily formed at a low cost.

Moreover, there is also an advantage that, compared to the suction device 1 of FIGS. 1 to 6 according to which pushing is performed by small regions of the distal ends of the piston rods 9a, the workpiece A may be stably pressed by a relatively large region by the strip-shaped member 16.

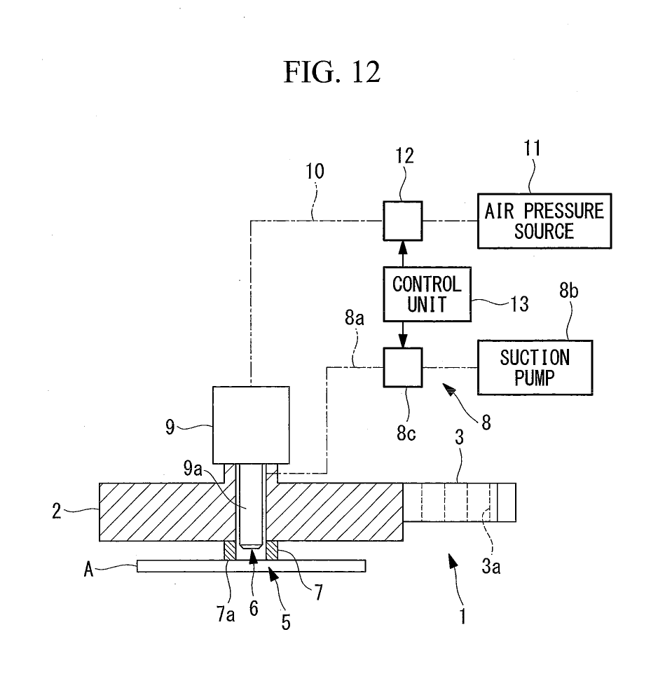

Furthermore, in the present embodiment, the pressing units 6 are arranged outside the annular suction pad 7, on both sides of the suction pad 7. Instead of the configuration, the piston rod 9a may be made to advance or retract inside the annular suction pad 7, as shown in FIGS. 11 and 12. This allows the configuration to be further facilitated. Additionally, application to a case where a sucking force is generated by a magnetic force by using the magnet 15, such as a permanent magnet or an electromagnet, as the annular suction pad 7 is also possible, in addition to a case where gripping is performed by placing the inside of the suction pad 7 in a reduced pressure state, as shown in FIG. 12.

Furthermore, in the present embodiment, a case is illustrated where the pressing unit 6 includes the air cylinder 9. Instead of the configuration, an arbitrary drive source (drive unit) for causing a pressing member, such as the piston rod 9a, to advance or retract may be adopted. For example, if a linear motion mechanism (not shown) which is driven by a motor (not shown) is adopted, the amount and speed of movement of the piston rod 9a may be adjusted based on the amount and speed of rotation of the motor.

As the linear motion mechanism, a mechanism combining a ball screw mechanism, a cam mechanism, or a crank mechanism with a servo motor, or a linear motor may be employed.

For example, in the case of releasing a small workpiece A on a conveyor belt or on a tray having a shape allowing a workpiece A to be perfectly fitted, adjustment of the amount and speed of protrusion of the piston rod 9a becomes important.

If the amount of protrusion is too small, there is an inconvenience that a workpiece A is not separated from the suction device 1 when there is a remaining sucking force or due to the influence of static electricity, and that the workpiece A cannot be released at an appropriate position. On the other hand, if the amount of protrusion is too great, interference with the tray or the conveyor belt may occur, and a workpiece A is possibly damaged, for example. By adjusting the amount of rotation of the motor, the amount of protrusion of the piston rod 9a may be appropriately adjusted, and occurrence of inconveniences described above may be prevented.

Moreover, if the speed of protrusion of the piston rod 9a is too slow, there is an inconvenience that the operation time is increased, thereby affecting the cycle time and resulting in reduced productivity. On the other hand, if the speed of protrusion is too fast, there is an inconvenience that the pressed workpiece A is pitched and cannot be released at a desired position. By adjusting the speed of rotation of the motor, the speed of protrusion of the piston rod 9a may be appropriately adjusted, and occurrence of inconveniences described above may be prevented.

Moreover, in the present embodiment, the timings of sucking by the suction portion 5 and pressing by the pressing unit 6 are adjusted by command signals transmitted from the control unit 13 connected to the valves 8c, 12. The timings may be adjusted for each of a plurality of suction portions 5 and pressing units 6. In the case of removing a workpiece A molded inside a cavity of a mold of an injection molding machine, the property at the time of separation of a workpiece A from a cavity may be different for each cavity. By adjusting the timings of start of sucking and the start of pressing with respect to workpieces A with slightly different properties, stable continuous operation is enabled.

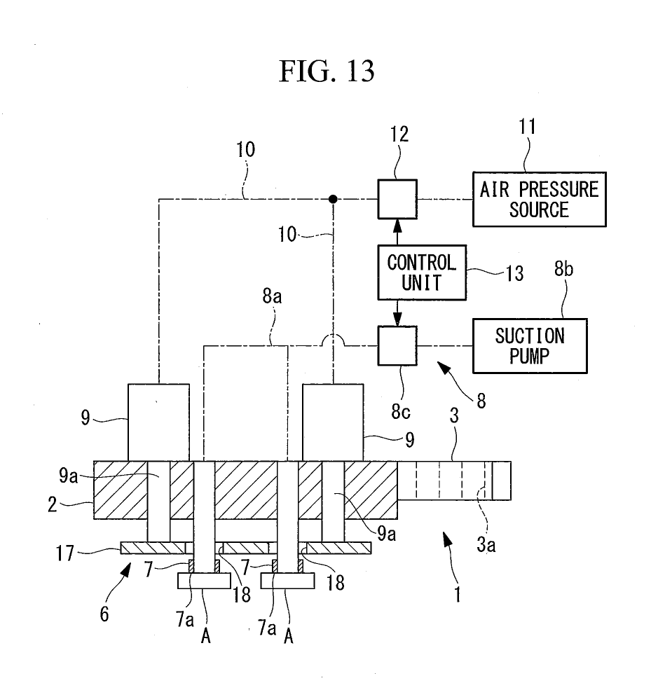

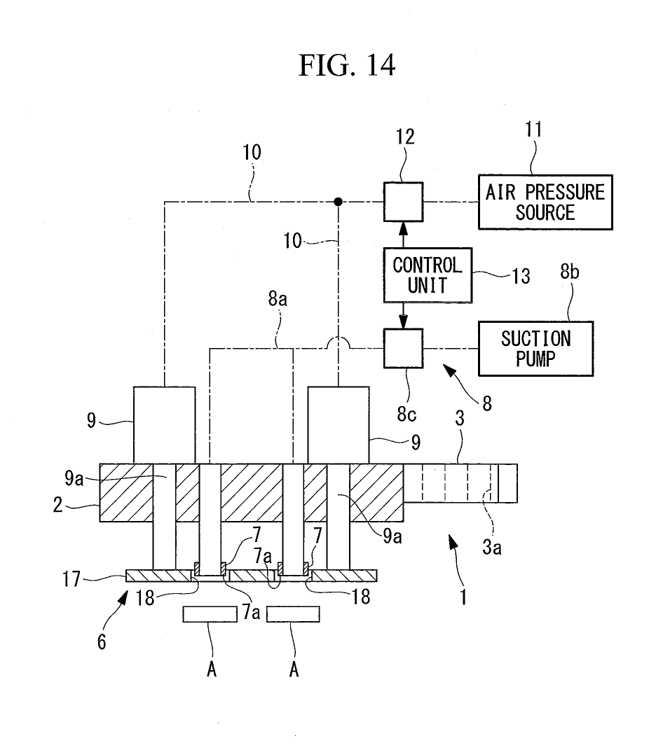

Also, in the example shown in FIG. 7, the plurality of workpieces A are simultaneously pushed by the strip-shaped members 16 which are attached to the piston rods 9a of the two air cylinders 9, respectively, and thereby the workpieces A are detached from the suction pads 7. Alternatively, as shown in FIGS. 13 and 14, it is possible to employ a plate-like member (pressing member) 17 which has penetrating holes 18 each of which the suction pad 7 can pass through and each of which has a smaller inner diameter than the outer diameter of each workpiece A.

In this case, when the piston rods 9a are retracted so that the suction pads 7 pass through the penetrating holes 18, which leads to a situation where the plate-like member 17 is positioned between the main body 2 and the distal end portions of the suction pads 7, the workpieces A can be gripped by the distal end portions of the suction pads 7. In this situation, when the piston rods 9a are advanced, the surfaces of the workpieces A gripped by the suction pads 7 are pushed by the plate-like member provided on the distal ends of the piston rods 9a, and it becomes possible to stop the gripped state of the workpieces A.

The inventor has arrived at the following aspects of the present invention.

An aspect of the present invention provides a suction device including a suction portion for gripping a suction target by using a sucking force in a direction; and a pressing unit which presses the suction target gripped by the suction portion in a direction opposite to the sucking force and which terminates a gripped state, wherein the pressing unit includes a pressing member provided in a manner capable of advancing and retracting along the direction of the sucking force in order to press the suction target, and a drive unit which advances and retracts the pressing member.

According to the aspect, at the time of gripping the suction target, the suction portion is brought close to the suction target so as to suck and grip the suction target by the action of the sucking force in a direction. Also, to terminate the gripped state of the suction target, the suction target is pressed by the pressing unit in a direction opposite to the direction of the sucking force, and the suction target can be forcibly separated from the suction portion even if there is a remaining sucking force, and the gripped state can be more reliably released. In this case, the suction portion and the pressing unit can be arranged according to the posture of the suction target, and a suction target arranged at any posture can be gripped.

With respect to the aspect described above, the suction portion may include an annular suction pad that comes into contact with the suction target, and a pressure-reducing device which reduces a pressure inside the suction pad, and the pressing member may be arranged inside the suction pad.

This allows the annular suction pad to be adhered to the suction target at the time of gripping the suction target, and the suction target may be gripped by a pressure difference caused by reducing the pressure inside the suction pad by the pressure-reducing device. Moreover, at the time of terminating the gripped state of the suction target, the pressing member is advanced inside the suction pad and the suction target is pressed in a direction away from the suction pad, and the gripped state may be more reliably terminated.

Furthermore, with respect to the aspect described above, the suction target may be made of a magnetic material, and the suction portion may grip the suction target by a magnetic force.

This allows, at the time of gripping of the suction target made of a magnetic material, the suction target to be sucked in and be gripped by a magnetic force, by bringing the suction portion close to the suction target and applying, to the suction target, a sucking force, in one direction, generated by a magnetic force generated by the suction portion. Also, at the time of releasing of the gripped state of the suction target, even if there is a remaining sucking force by the magnetic force, the suction target may be forcibly separated from the suction portion by pressing the suction target by the pressing unit in a direction opposite to the direction of the sucking force, and the gripped state may be more reliably released.

Furthermore, with respect to the aspect described above, the suction portion may be formed into an annular shape, and the pressing member may be arranged inside the suction portion.

This allows, at the time of gripping of the suction target, the suction target to be gripped by a magnetic force by bringing the annular suction portion close to the suction target and causing a magnetic force to act. Also, at the time of releasing of the gripped state of the suction target, the pressing member is advanced inside the annular suction portion and the suction target is pressed in a direction away from the suction portion, and the magnetic force is thereby cut off, and the gripped state may be more reliably released.

Furthermore, with respect to the aspect described above, the pressing member may be arranged at at least two positions sandwiching the suction portion and outside the suction portion, so as to press the suction target.

This allows the suction target to be pushed in a direction opposite to the sucking force at at least two positions sandwiching the part that is being gripped by the suction portion, and the pressing force may be spread, and also, the posture of the suction target at the time of releasing of the grip may be stably maintained.

Furthermore, with respect to the aspect described above, the pressing member may have a penetrating hole which the suction portion can pass through and which has a smaller inner diameter than an outer diameter of the suction portion, and the drive unit may be configured to advance and retract the pressing member between a first position where the suction portion is retracted in the penetrating hole and a second position where the suction portion is protruded from the penetrating hole.

With this configuration, the suction target is gripped by the suction portion by positioning the pressing member by the drive unit so that the suction portion is protruded from the penetrating hole. Also, when the pressing member is moved by the drive unit to a position where the suction portion is retracted in the penetrating hole, the suction target is pushed to a direction in which the suction target is detached from the suction portion by the pressing member abutting against the suction target gripped by the suction portion, which affords an advantage that the gripped state is more reliably terminated.

Furthermore, with respect to the aspect described above, a plurality of the suction portions may be provided, and each of the suction portions may be provided with the pressing member which can be driven independently.

This allows suction targets gripped by different suction portions to be separately pressed, and the gripped states may be released at different positions or at different timings.

Furthermore, with respect to the aspect described above, a plurality of the suction portions may be provided, and the pressing member may be provided in a manner capable of pressing a plurality of the suction targets gripped by the suction portions.

This allows different suction targets gripped by different suction portions to be pressed by a shared pressing member, and the gripped states may be terminated at the same time. The number of pressing members may thus be reduced, and the suction device may be easily configured.

Furthermore, the drive unit may be capable of adjusting an amount of movement of the pressing member.

This allows the pressing member to advance by an amount of movement that is neither excessive nor insufficient, and interference with a peripheral device, at the time of releasing of the gripped state, due to the pressing member being pushed too much, or insufficient releasing of the gripped state due to the pressing member not being sufficiently pushed may be prevented.

Furthermore, with respect to the aspect described above, the drive unit may be capable of adjusting a speed of movement of the pressing member.

This allows the pressing member to advance at a speed of movement that is neither excessive nor insufficient, and an increase in the time required to release the gripped state of the suction target due to the speed being too slow, or pitching of the suction target due to the speed being too fast may be prevented.

Furthermore, with respect to the aspect described above, a control unit which can adjust timings of stopping sucking by the suction portion and of starting pressing by the pressing unit may be further provided.

This allows, at the time of releasing of the gripped state of the suction target, the timings of stopping sucking by the suction portion and of starting pressing by the pressing unit to be adjusted by the control unit, and the gripped state may be appropriately released according to the gripping property of the suction portion.

According to the aforementioned aspects, advantages that a gripped, and that the grip can be terminated more reliability are achieved.

### REFERENCE SIGNS LIST

1 suction device
5 suction portion
6 pressing unit
7 suction pad
8 pressure-reducing device
9a piston rod (pressing member)
12 valve (drive unit)
13 control unit
15 magnet (suction portion)
A workpiece (suction target)

1. A suction device comprising:
a suction portion for gripping a suction target by using a sucking force in a direction;
a pressing unit which presses the suction target gripped by the suction portion in a direction opposite to the sucking force and which terminates a gripped state; and
wherein the pressing unit includes a pressing member provided in a manner capable of advancing and retracting along the direction of the sucking force in order to press the suction target, and a drive unit which advances and retracts the pressing member.

2. The suction device according to claim 1, wherein:
the suction portion includes an annular suction pad that comes into contact with the suction target and a pressure-reducing device which reduces a pressure inside the suction pad; and
the pressing member is arranged inside the suction pad.

3. The suction device according to claim 1, wherein:
the suction target is made of a magnetic material; and
the suction portion grips the suction target by a magnetic force.

4. The suction device according to claim 3, wherein:
the suction portion is formed into an annular shape; and
the pressing member is arranged inside the suction portion.

5. The suction device according to claim 1, wherein pressing members are arranged at at least two positions sandwiching the suction portion and outside the suction portion, so as to press the suction target.

6. The suction device according to claim 1, wherein:
the pressing member has a penetrating hole which the suction portion can pass through and which has a smaller inner diameter than an outer diameter of the suction portion; and
the drive unit is configured to advance and retract the pressing member between a first position where the suction portion is retracted in the penetrating hole and a second position where the suction portion is protruded from the penetrating hole.

7. The suction device according to claim 1, wherein:
a plurality of the suction portions are provided; and
each of the suction portions is provided with the pressing member which can be driven independently.

8. The suction device according to claim 1, wherein:
a plurality of the suction portions are provided; and
the pressing member is provided in a manner capable of pressing a plurality of the suction targets gripped by the suction portions.

9. The suction device according to claim 1, wherein the drive unit is capable of adjusting an amount of movement of the pressing member.

10. The suction device according to claim 1, wherein the drive unit is capable of adjusting a speed of movement of the pressing member.

11. The suction device according to claim 1, comprising a control unit which can adjust timings of stopping sucking by the suction portion and of starting pressing by the pressing unit.
